(19) United States
(12) Patent Application Publication
(10) Pub. No.: US 2025/0314319 A1
(43) Pub. Date: Oct. 9, 2025

(54) FAST-RESPONDING PASSIVE FLOW RATE LIMITING VALVE FOR HIGH PRESSURE GAS APPLICATIONS

(71) Applicant: KALSI ENGINEERING, INC., Sugar Land, TX (US)

(72) Inventors: Mital Chandrakant MISTRY, Richmond, TX (US); Zachary Wade LEUTWYLER, Richmond, TX (US); Manmohan S. KALSI, Houston, TX (US)

(73) Assignee: KALSI ENGINEERING, INC., Sugar Land, TX (US)

(21) Appl. No.: 19/172,310

(22) Filed: Apr. 7, 2025

Related U.S. Application Data
(60) Provisional application No. 63/731,160, filed on Apr. 5, 2024.

(51) Int. Cl. F16K 17/30

(52) U.S. Cl. CPC F16K 17/30; F16K 2200/304; F16K 2200/402

(57) ABSTRACT

A fast-responding passive flow rate limiting valve for high pressure gas applications, the valve comprising a valve body having a flow passageway extending from an upstream end to a downstream end of the valve body. The flow passageway includes a first bore portion in the upstream end of the valve body in fluid communication with one or more ports spaced around an inner passageway in the upstream end of the valve body. The inner passageway and one or more ports extend to a body elongate bore which extends to the downstream end of the valve body. A poppet extends into and through the inner passageway and includes an inner bore having a plurality of poppet ports. In a poppet open position the poppet ports are unobstructed and open to the first bore portion and in a poppet closed position the poppet ports are within the inner passageway and at least partially obstructed. A spring, received within the body elongate bore, provides a spring force on the poppet in an upstream direction. The valve rapidly transitions from the open position to the closed position upon an upstream fluid pressure spike acting on the poppet causing a restriction to fluid flow and quickly limiting the flow rate through the valve.

### CROSS-REFERENCE TO RELATED APPLICATIONS

This application claims the benefit of U.S. Provisional Application Ser. No. 63/731,160 filed on Apr. 5, 2024, entitled “Fast Responding Passive Flow Rate Limiting Valve For High Pressure Gas Applications.” Applicant incorporates by reference herein Application Ser. No. 63/731,160 in its entirety.

### STATEMENT REGARDING FEDERALLY SPONSORED RESEARCH OR DEVELOPMENT

This invention was made with Government support under Contract No. DE-SC0023918, awarded by Office of Science, U.S. Department of Energy. The Government therefore has certain rights in this invention.

### BACKGROUND OF THE INVENTION

### 1. Field of the Invention

The present invention relates generally to flow limiting valves for high pressure gas applications, and more particularly to passive, fast-responding flow rate limiting valves for high pressure gas applications.

### 2. Description of the Related Art

In many high pressure gas applications, such as a hydrogen fueling system, the process environment of the hydrogen fueling station is dominated by a continuous state of highly transient conditions. Transient conditions include sharp changes in pressure caused by switching between supply tanks, rapid decrease in pressure (due to mass depletion and inherent cooling of hydrogen in the supply tank), and pressure increase in the vehicle fuel tank. Due to these ever-changing conditions, the plant and valve control loops are constantly chasing the target mass flow rate. Continuous and substantial valve position changes introduce secondary effects. Rapid changes in valve position cause changes in the mass flow, which induces additional pressure transients. Because of the highly transient state of the system and inherent consequence of using a fast-acting control system to control a single, fast-acting control valve, substantial and frequent deviations in mass flow rate are inevitable.

The hydrogen refueling system is composed of multiple high pressure supply or storage tanks that are connected to a common header. The flow rate from the header is controlled via a flow control valve that is typically located in the dispenser. Supply from the supply tanks is sequenced to maintain timely transfer to the receiving tank, as for example a vehicle tank. The sequence consists of staging the supply tanks so that only one supply tank (or set of tanks) is active at a time. When the pressure in the active supply tank decreases to a certain value, that tank is isolated and the next supply tank in the sequence becomes active. Switching to the next active supply tank suddenly increases the differential pressure acting across the flow control valve. The transient caused by switching between supply tanks results in frequent and substantial flow control valve cycling. If the flow control valve does not respond quickly, a substantial increase in mass flow rate occurs at the onset of tank switching.

It would be desirable for a high pressure gas application system having a flow control valve to deliver rapid control responses and ensure the flow rate remains within specified limits.

It would be desirable to have a fast-responding passive flow rate limiting valve adapted for service in high pressure gas applications, including hydrogen refueling systems and applications.

It would be desirable to have a fast-responding passive flow rate limiting valve that can be integrated into existing systems having a flow control valve to deliver rapid control responses and ensure the flow rate remains within specified limits.

### SUMMARY OF THE INVENTION

One aspect of the present invention relates generally to a fast-responding passive flow rate limiting valve designed for high pressure gas applications. The fast-responding passive flow rate limiting valve may be used with a downstream control valve.

The fast-responding passive flow rate limiting valve can be integrated into existing systems having a flow control valve to deliver rapid control responses and ensure the flow rate remains within specified limits. The passive flow rate limiting valve, used in conjunction with a downstream active flow control valve, can achieve two distinct flow resistances. Under high differential pressure conditions, a valve poppet closes, increasing the flow resistance beyond what the active flow control valve can quickly achieve, thereby limiting the flow rate. When the differential pressure drops below the design reset value, the poppet reopens, producing a lower flow resistance and allowing the active flow control valve to regain control of the flow rate.

### BRIEF DESCRIPTION OF THE SEVERAL VIEWS OF THE DRAWINGS

The aspects, features, and advantages of the embodiments of the invention mentioned above are described in more detail by reference to the drawings, wherein like reference numerals represent like elements having the same basic function, in which:

FIG. 1 is a simplified schematic drawing of a system having a plurality of supply tanks, a flow rate limiting valve, a flow control valve and a tank to be filled with a pressurized gas;

FIG. 2 is a longitudinal cross-sectional view of a passive flow rate limiting valve according to an embodiment of the present invention, the valve having a poppet shown in an open position;

FIG. 3 is a view of the passive flow rate limiting valve of FIG. 2 but with the poppet in a closed position;

FIG. 4 is a longitudinal cross-sectional view of a passive flow rate limiting valve according to a second embodiment of the present invention with a valve poppet in an open position;

FIG. 5 is a view of the passive flow rate limiting valve of FIG. 4 but with the poppet in a closed position; and

FIG. 6 is a longitudinal cross-sectional view of the passive flow rate limiting valve according to the second embodiment of the present invention with Belleville springs and the valve poppet in an open position.

### DESCRIPTION OF THE PREFERRED EMBODIMENTS

The following brief definition of terms shall apply throughout the application:

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the field of the art;

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiment, or it may be excluded.

Embodiments of the invention will now be described with reference to the figures, in which like numerals reflect like elements throughout. The terminology used in the description presented herein is not intended to be interpreted in any restrictive or limited way, simply because it is being utilized in conjunction with the detailed description of certain specific embodiments of the invention. Furthermore, embodiments of the invention may include several novel features, no single one of which is solely responsible for its desirable attributes or which is essential to practicing the invention described herein.

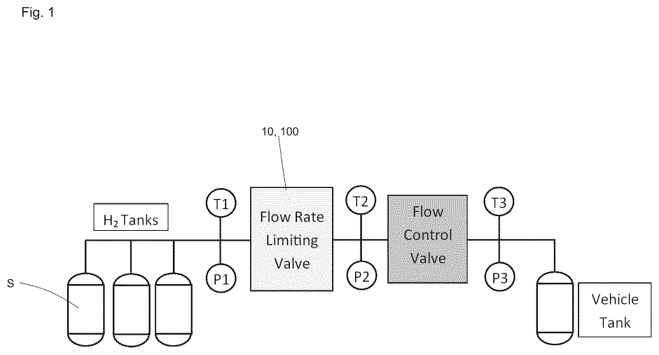

FIG. 1 is a simplified schematic drawing of a representative high pressure gas application system in which a fast-responding passive flow rate limiting valve of the present invention 10, 100 may be used. As one example, the fast-responding passive flow rate limiting valve 10, 100 can be installed in a hydrogen fueling station between a plurality of high-pressure hydrogen storage tanks S and a flow control valve. The hydrogen fueling station adapted to provide high pressure hydrogen to a vehicle tank as shown in FIG. 1. One example of a flow control valve that the flow rate limiting valve could be used with is in applicant's pending U.S. application Ser. No. 18/645,092. Applicant incorporates by reference herein U.S. application Ser. No. 18/645,092 in its entirety.

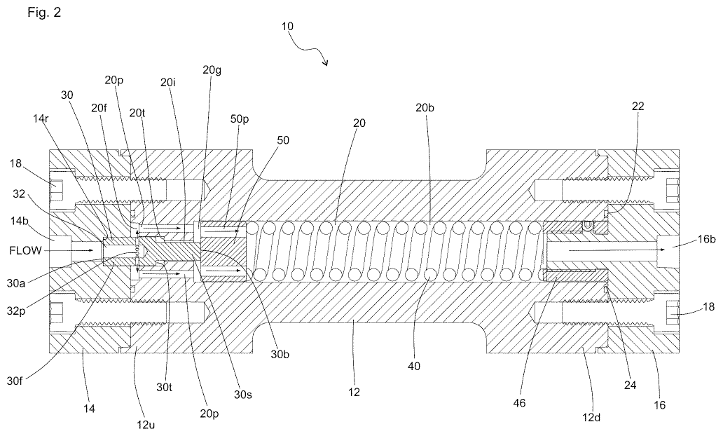

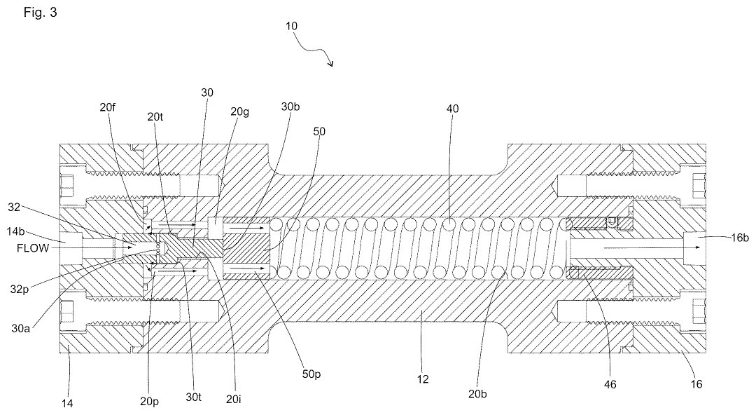

FIGS. 2 and 3 show a first embodiment of the fast-responding passive flow rate limiting valve, generally referred to as 10. The limiting valve 10 includes a valve body 12 and may have upstream and downstream flanges 14 and 16, respectively, adapted to be connected to upstream and downstream ends 12u and 12d, respectively, of the valve body 12 with fasteners 18, as for example threaded fasteners.

The valve body 12 includes a flow passageway 20 extending from the upstream end 12u to the downstream end 12d of the valve body 12. The flow passageway 20 includes a first portion having a first bore portion 20f in the upstream end 12u of the valve body 12. The first bore portion 20f is in fluid communication with one or more ports 20p spaced around an inner passageway 20i in the upstream end 12u of the valve body 12. The ports 20p and inner passageway 20i extend to a body elongate bore 20b which extends to the downstream end 12d of the valve body 12. A seal ring 22 received in a groove 24 around the flow passageway 20 may be located at the upstream end 12u of the valve body 12 and at the downstream end 12d of the valve body 12 to form a fluid-tight seal between the valve body 12 and the upstream and downstream flanges 14, 16.

A poppet 30 is designed to extend into and through the inner passageway 20i. Preferably, the poppet 30 has a first portion 30f and a second portion 30s. Preferably, the first and second portions 30f, 30s are cylindrical and have different outer diameters defining a stepped outer surface. A face 30t, preferably a transverse face, may form the transition between the first and second portions 30f, 30s. The inner passageway 20i has a complementary stepped inner surface corresponding to the stepped outer surface of the poppet 30 and a wall 20t, preferably a transverse wall, adapted to engage the face 30t when the poppet 30 is in the closed position as shown in FIG. 3.

The poppet 30 includes an inner bore 32 in the first portion 30f of the poppet 30. The inner bore 32 does not extend axially through the poppet 32 but includes a plurality of poppet ports 32p, preferably near an end of the axial portion of the inner bore 32. Preferably, the poppet ports 32p are radially-oriented.

Preferably, a spring 40 is received in the body elongate bore 20b. The body elongate bore 20b may also receive a spring preload adjustment adapter 46 adjacent the downstream flange 16. In the flow rate limiting valve 10, the spring preload is sized such that there is always a net positive force to close the poppet 30 at a desired closing differential pressure. A spring base 50 is received in the body elongate bore 20b near the upstream end 12u of the valve body 12. The spring base 50 is allowed to move or slide within the body elongate bore 20b. The spring base 50 preferably includes one or more base passageways 50p extending through the spring base 50.

The upstream flange 14 includes a bore 14b in fluid communication with the inner bore 32 of the poppet 30 and the downstream flange 16 includes a bore 16b in fluid communication with the body elongate bore 20b.

With reference to FIG. 2, the upstream flange 14 includes a restraint or ledge 14r in the bore 14b which preferably contacts and abuts a first end 30a of the poppet 30 when the poppet is in the open position. In the open position, the plurality of poppet ports 32p are preferably fully open to and fluidly communicate with the first bore portion 20f of the valve body 12.

The second portion 30s of the poppet has a second end 30b preferably contacting the spring base 50. As shown in FIG. 2, it may be desirable to maintain a gap or small distance 20g between the spring base 50 and the body wall defining the upstream end of the body elongate bore 20b when the poppet 30 is in the open position. The gap 20g permits fluid to easily flow from the valve body ports 20p to the base passageways 50p even if not axially aligned with each other.

The spring 40 contacts or abuts the spring base 50 at one end and the spring preload adjustment adapter 46 at a second end. The spring 40 is preferably a compression spring and is shown in FIGS. 2 and 3 as a coil spring, however, other types of springs may be used as for example, but not limiting, Belleville springs and conical spring washers. The spring 40 is preloaded to keep the poppet 30 open under a no-flow condition or when the differential pressure across the poppet 30 is low.

As shown by the arrows in FIG. 2, the fluid flows through upstream flange bore 14b, poppet inner bore and open ports 32, 32p, valve body first bore portion 20f and ports 20p, gap 20g, base passageways 50p, body elongate bore 20b, and downstream flange bore 16b.

FIG. 3 shows the poppet 30 in the closed position. As discussed above, during upstream tank switching, a sudden pressure spike increases the differential pressure across the poppet 30 generating enough force to overcome the spring preload and close the poppet 30. As shown in FIG. 3, the high pressure acting on the upstream side of the poppet 30 (resulting from, for example, tank switching) forces the poppet 30 to slide axially within the inner passageway 20i in the downstream direction, resulting in the poppet ports 32p being received within the inner passageway 20i. As discussed above, the inner passageway 20i has a complementary stepped inner surface corresponding to the stepped outer surface of the poppet 30. When the poppet 30 closes, the fluid is restricted to a narrow annular passage between the poppet 30 and the valve body 12 which significantly reduces flow. The poppet face 30t may contact the wall 20t of the inner passageway 20i to limit downstream movement of the poppet 30 upon closing. Additionally, the contact of the poppet face 30t with the wall 20t may restrict or obstruct the fluid flow therebetween and force the fluid to flow in the annular area from the poppet ports 30p to the first bore portion 20f as shown by the arrows in FIG. 3.

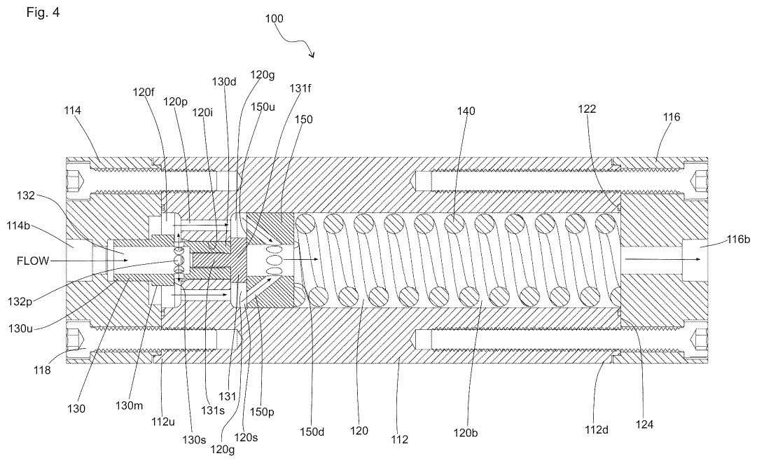

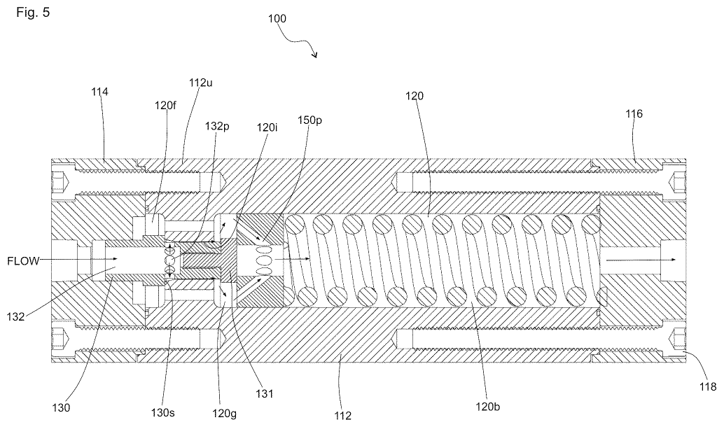

FIGS. 4 and 5 show another embodiment of the passive flow rate limiting valve, generally referred to as 100. FIGS. 4 and 5 show the valve 100 in the open and closed positions, respectively. The limiting valve 100 includes a valve body 112 and may have upstream and downstream flanges 114 and 116, respectively, adapted to be connected to upstream and downstream ends 112u and 112d, respectively, of the valve body 112 with fasteners 118, as for example threaded fasteners.

The valve body 112 includes a flow passageway 120 extending from the upstream end 112u to the downstream end 112d of the valve body 112. The flow passageway 120 includes a first portion having a first bore portion 120f in the upstream end 112u of the valve body 112. The first bore portion 120f is in fluid communication with one or more ports 120p spaced around an inner passageway 120i in the upstream end 112u of the valve body 112. The ports 120p and inner passageway 120i extend to a body elongate bore 120b which extends to the downstream end 112d of the valve body 112. A seal ring 122 received in a groove 124 around the flow passageway 120 may be located at the upstream end 112u of the valve body 112 and at the downstream end 112d of the valve body 112 to form a fluid-tight seal between the valve body 112 and the upstream and downstream flanges 114, 116.

A poppet 130 is designed to extend into and through the inner passageway 120i. The poppet 130 may be a split or two-piece poppet to accommodate assembly of the valve 100 as will be described below. The poppet 130 includes an upstream portion 130u, a medial portion 130m and a downstream portion 130d. Preferably, the poppet 130 includes an outer shoulder 130s having a diameter larger than the inner passageway 120i. The poppet upstream portion 130u may be received within a portion of the upstream flange bore 114b and the poppet medial portion 130m and outer shoulder 130s may be at least partially received in the first bore portion 120f of the valve body 112. The poppet downstream portion 130d is received in the inner passageway 120i. The The poppet 130 includes a flange member 131 comprising a flange 131f and a stem 131s. The stem 131s is preferably secured to the downstream portion 130d of the poppet 130 and the flange 131f abuts the upstream side 150u of the spring base 150. The stem 131s may be threadedly connected to downstream portion 130d of the poppet 130.

The poppet 130 includes an inner bore 132 open at an upstream end of the poppet 130. The inner bore 132 includes a plurality of poppet ports 132p, preferably near an end of the axial portion of the inner bore 132. Preferably, the poppet ports 132p are radially-oriented.

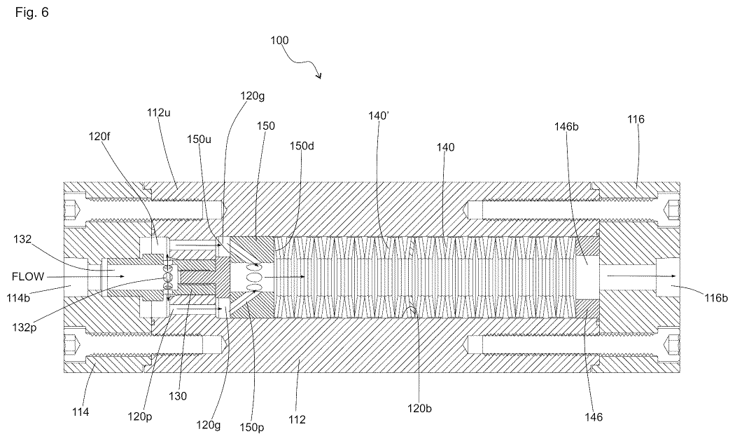

A spring 140, preferably a compression spring, is received in the body elongate bore 120b. The spring 140 is shown in FIGS. 4 and 5 as a coil spring. In FIG. 6, the coil spring 140 has been replaced with a stack of Belleville springs or conical spring washers 140′. As shown in FIGS. 4-6, a spring base 150 is received in the body elongate bore 120b near the upstream end 112u of the valve body 112. The spring base 150 is allowed to move or slide within the body elongate bore 120b. The spring base 150 preferably includes one or more base passageways 150p extending through the spring base 150 to allow fluid flow from the upstream side 150u to the downstream side 150d of the spring base 150.

A spring preload adjustment adapter 146 to adjust the spring preload, preferably in the form of a spacer having a bore 146b therethrough, may be positioned between the downstream flange 116 and the downstream end of the spring 140, 140′ as shown in FIG. 6. Although not shown, it is to be understood that the adjustment adapter 146 could be similarly positioned in the valve 100 shown in FIGS. 4 and 5. In the flow rate limiting valve 100, the spring preload is sized such that there is always a net positive force to close the poppet 130 at a desired closing differential pressure.

The upstream flange 114 includes a bore 114b in fluid communication with the inner bore 132 of the poppet 130 and the downstream flange 116 includes a bore 116b in fluid communication with the body elongate bore 120b and the adapter bore 146b.

Preferably, the upstream, medial and downstream portions 130u, 130m, 130d, respectively, of the poppet 130 are cylindrical and may have different outer diameters. The annular flow passage between the valve body inner passageway 120i and the poppet downstream portion 130d determines the flow resistance when the poppet 130 is in the closed position. By changing the outer diameter of the poppet downstream portion 130d, different flow resistances and corresponding mass flow rate may be achieved in the closed position. The outer diameter of the poppet upstream portion 130u controls the poppet guiding clearance, while the outside diameter of the poppet medial portion 130m provides sealing (although not a tight seal) and restricts the flow when the poppet 130 is closed.

With reference to FIG. 4, the flange 131f of the poppet flange member 131 preferably has a diameter larger than the diameter of the inner passageway 120i of the valve body 112. The flange 131f preferably contacts and abuts the valve body 112 in the area around the downstream end of the inner passageway 120i when the poppet 130 is in the open position as shown in FIGS. 4 and 6. The abutting contact of the flange 131f and valve body 112 restricts flow through the annular passageway when the poppet is in the open position. The flange 131f limits the movement of the poppet 130 in the upstream direction. Further, when the poppet 130 is in the open position, the plurality of poppet ports 132p are preferably fully or substantially fully open to and fluidly communicate with the first bore portion 120f of the valve body 112.

As shown in FIGS. 4 and 6, the flange 131f maintains a gap or small distance 120g between the spring base 150 and the body wall defining the upstream end of the body elongate bore 120b when the poppet 130 is in the open position. The gap 120g permits fluid to easily flow from the valve body ports 120p to the base passageways 150p even if not aligned with each other.

The spring 140, 140′ contacts or abuts the spring base 150 at one end and the downstream flange 116 or the adjustment adapter 146 (FIG. 6) at a second end. The spring 140, 140′ is preloaded to keep the poppet 130 open under a no-flow condition or when the differential pressure across the poppet 130 is low. It is to be understood that spacers of different thicknesses may be used to adjust the spring preload.

As shown by the arrows in FIGS. 4 and 6, when the poppet 130 is in the open position the fluid flows through upstream flange bore 114b, poppet inner bore and open ports 132, 132p, valve body first bore portion 120f and ports 120p, gap 120g, base passageways 150p, body elongate bore 120b, adapter bore 146b and downstream flange bore 116b.

FIG. 5 shows the poppet 130 in the closed position. As discussed above, during upstream tank switching, a sudden pressure spike increases the differential pressure across the poppet 130 generating enough force to overcome the spring preload and close the poppet 130. As shown in FIG. 5, the high pressure acting on the upstream side of the poppet 130 (resulting from, for example, tank switching) forces the poppet 130 to slide axially in the downstream direction, resulting in the poppet ports 132p being received within the inner passageway 120i. When the poppet 130 closes, the poppet shoulder 130s is forced into contact with and abuts the valve body 112 in the area around the upstream end of the inner passageway 120i. The poppet shoulder 130s limits the movement of the poppet 130 in the downstream direction. Further, when the poppet 130 is in the closed position, the plurality of poppet ports 132p are substantially obstructed by the borewall of the inner passageway 120i. In the closed position, the fluid is restricted to a narrow annular passage between the poppet downstream portion 130d and the borewall of the inner passageway 120i, which significantly reduces flow. Additionally, the contact of the poppet shoulder 130s with the portion of the valve body 112 around the upstream end of the inner passageway 120i closes off the fluid flow path to the first bore portion 120f and the fluid is forced to flow from the restricted annular passage to the gap 120g as shown by the arrows in FIG. 5. In the flow rate limiting valve 100 shown in FIGS. 4-6, the flow is through the valve body ports 120p in the open position and through the valve body inner passageway 120i in the closed position.

### Nomenclature

fast-responding passive flow rate limiting valve 10
valve body 12
downstream end 12d
upstream end 12u
upstream flange 14
bore 14b
restraint 14r
downstream flange 16
bore 16b
fasteners 18
flow passageway 20
body elongate bore 20b
first bore portion 20f
gap 20g
inner passageway 20i
ports 20p
transverse wall 20t
seal ring 22
groove 24
poppet 30
first end 30a
second end 30b
first portion 30f
second portion 30s
transverse face 30t
inner bore 32
poppet ports 32p
spring 40
spring preload adjustment adapter 46
spring base 50
base passageways 50p
fast-responding passive flow rate limiting valve 100
valve body 112
downstream end 112d
upstream end 112u
upstream flange 114
bore 114b
downstream flange 116
bore 116b
fasteners 118
flow passageway 120
body elongate bore 120b
first bore portion 120f
gap 120g
inner passageway 120i
ports 120p
seal ring 122
groove 124
poppet 130
downstream portion 130d
medial portion 130m
outer shoulder 130s
upstream portion 130u
flange member 131
flange 131f
stem 131s
inner bore 132
poppet ports 132p
spring 140
Belleville springs (conical spring washers) 140′
spring preload adjustment adapter 146
adapter bore 146b
spring base 150
downstream side 150d
base passageways 150p
upstream side 150u

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

We claim:

1. A fast-responding passive flow rate limiting valve for high pressure gas applications, the valve comprising:
a body assembly comprising a valve body, an upstream flange and a downstream flange, the upstream and downstream flanges connected to the valve body;
the valve body having a flow passageway extending from an upstream end to a downstream end of the valve body, the flow passageway comprising a first bore portion in the upstream end of the valve body in fluid communication with one or more ports spaced around an inner passageway in the upstream end of the valve body, and the inner passageway and one or more ports extend to a body elongate bore which extends to the downstream end of the valve body;
a poppet arranged and designed to extend into and through the inner passageway, the poppet comprising an inner bore having a plurality of poppet ports, the poppet having an open position and a closed position, in the open position the poppet ports are unobstructed and open to the first bore portion and in the closed position the poppet ports are within the inner passageway and at least partially obstructed;
a spring received within the body elongate bore, the spring providing a spring force on the poppet in an upstream direction;
wherein the valve rapidly transitions from the open position to the closed position upon an upstream fluid pressure spike acting on the poppet causing a restriction to fluid flow and quickly limiting the flow rate through the valve.

2. The fast-responding passive flow rate limiting valve of claim 1, further comprising:
the upstream flange having an upstream flange bore in fluid communication with the poppet inner bore;
the downstream flange having a downstream flange bore in fluid communication with the body elongate bore;
wherein in the open position, fluid flows from the upstream flange bore to the poppet inner bore and poppet ports to the one or more valve body ports to the body elongate bore to the downstream flange bore.

3. The fast-responding passive flow rate limiting valve of claim 2, wherein in the closed position, fluid flows from the upstream flange bore to the poppet inner bore and poppet ports to a restricted annular passage between the poppet and the inner passageway to the one or more valve body ports to the body elongate bore to the downstream flange bore.

4. The fast-responding passive flow rate limiting valve of claim 2, wherein in the closed position, fluid flows from the upstream flange bore to the poppet inner bore and poppet ports to a restricted annular passage between the poppet and the inner passageway to the body elongate bore to the downstream flange bore.

5. The fast-responding passive flow rate limiting valve of claim 1, wherein the plurality of poppet ports are radially-oriented.

6. The fast-responding passive flow rate limiting valve of claim 1, further comprising a spring base having one or more base passageways therethrough, the spring base received in an upstream end of the body elongate bore between the spring and the poppet and in contact with the spring and poppet.

7. The fast-responding passive flow rate limiting valve of claim 1, further comprising a spring preload adjustment adapter received in a downstream end of the body elongate bore between the spring and the downstream flange and in contact with the spring,
wherein a spring preload is sized such that there is always a net positive force to close the poppet at a desired closing differential pressure.

8. The fast-responding passive flow rate limiting valve of claim 1, further comprising:
the poppet comprising first and second cylindrical portions having different outer diameters defining a stepped outer surface and a transverse face forming the transition between the first and second portions; and
the inner passageway having a complementary stepped inner surface corresponding to the stepped outer surface of the poppet and a transverse wall adapted to engage the transverse face when the poppet is in the closed position.

9. The fast-responding passive flow rate limiting valve of claim 1, further comprising the poppet including a medial portion and a downstream portion, the poppet having an outer shoulder having a diameter larger than the diameter of the inner passageway,
wherein the poppet medial portion and outer shoulder are at least partially received in the first bore portion of the valve body and the poppet downstream portion is received in the inner passageway,
wherein when the poppet closes, the poppet outer shoulder is forced into contact with and abuts the valve body in the area around the upstream end of the inner passageway closing off the fluid flow path to the first bore portion such that the fluid is forced to flow from the restricted annular passage between the poppet downstream portion and the inner passageway directly to the body elongate bore.

10. The fast-responding passive flow rate limiting valve of claim 9, wherein poppet outer shoulder limits the movement of the poppet in the downstream direction.

11. A fast-responding passive flow rate limiting valve for installation between high pressure storage tanks and a flow control valve in a high pressure gas application, the limiting valve comprising:
a valve body having a flow passageway extending from an upstream end to a downstream end of the valve body, the flow passageway comprising a first bore portion in the upstream end of the valve body in fluid communication with one or more ports spaced around an inner passageway in the upstream end of the valve body, and the inner passageway and one or more ports extend to a body elongate bore which extends to the downstream end of the valve body;
a poppet arranged and designed to extend into and through the inner passageway, the poppet comprising an inner bore having a plurality of poppet ports, the poppet having an open position and a closed position, in the open position the poppet ports are unobstructed and open to the first bore portion and in the closed position the poppet ports are within the inner passageway and at least partially obstructed;
a spring received within the body elongate bore, the spring providing a spring force on the poppet in an upstream direction;
wherein the valve rapidly transitions from the open position to the closed position upon an upstream fluid pressure spike acting on the poppet causing a restriction to fluid flow and quickly limiting the flow rate through the valve.
